(19) United States
(12) Patent Application Publication
(10) Pub. No.: US 2006/0067330 A1
(43) Pub. Date: Mar. 30, 2006

(54) Method and arrangement for routing data packets in a packet-switched data network

(75) Inventors: Gero Schollmeier, Gauting (DE); Christian Winkler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft, Muenchen (DE)

(21) Appl. No.: 10/546,948

(22) PCT Filed: Mar. 31, 2003
(86) PCT No.: PCT/DE03/01050

§ 371 Date: Aug. 25, 2005

(30) Foreign Application Priority Data
Feb. 27, 2003 (DE) 103 08 614.5

(51) Int. Cl. H04L 12/56; H04L 12/28

(52) U.S. Cl. 370/395.31

(57) ABSTRACT

The invention relates to a method, whereby between two adjacent network nodes which together comprise at least two parallel connecting paths and each comprise one routing table containing path information, said connecting paths are operated as independent transmission paths by means of corresponding entries in the routing tables.

### CROSS REFERENCE TO RELATED APPLICATIONS

This application claims priority to the German application No. 10308614.5, filed Feb. 27, 2003 and to the International Application No. PCT/DE2003/001050, filed Mar. 31, 2003 which are incorporated by reference herein in their entirety.

### FIELD OF INVENTION

The invention relates to a method and arrangement for routing data packets in a packet-switched data network.

### BACKGROUND OF INVENTION

In an earlier patent application, a method is proposed which uses so-called “joker links” for switching as replacements for disrupted or failed connections between network nodes of a packet-switched data network. These “joker links” do not, under disruption-free conditions, transmit any data to a given destination or to a given destination address or destination point code, but are activated only in the event of disruptions or failures of connections used as primary connections to a given destination address. This is intended to prevent routing loops, especially in the case of multipath routing.

### SUMMARY OF INVENTION

An example should make this clear. FIG. 1 shows an arrangement of a part of a packet-switched data network, for example an Internet Protocol (IP) network, consisting of three network nodes A, B and D, such as for example routers, switches, gateways, network elements or other similar switching devices. The network nodes A and B, B and D, and A and D are connected to one another via connections or links ab, bd and ad. The network nodes A and B have connections, via which they receive data packets, to a part of the data network that is not shown.

Data packets which arrive at the network node B from the part of the data network not shown and are intended to be routed or switched onward to the destination network node D will be examined. There are two paths to the destination network node D: firstly directly via the connection bd and secondly via the connection ab to the network node A and from this network node by means of the connection ad to the destination network node D.

In the case of normal, so-called shortest-path routing, the network node B would always route packets to the network node D via the connection bd, and the network node A would always route packets to the network node D via the connection ad.

In the case of multipath routing, the traffic is divided between two or more paths. The obvious alternative path is that via network node A. That is, the network node B also routes packets to the network node D via the connection ab to the network node A, from where they are forwarded via the connection ad to the network node D. Analogously, the network node A could route packets to the network node D via the connection ab to the network node B, from where they are forwarded via the connection bd to the network node D. The routing tables, including the traffic distribution weightings p₁ and p₃, for the alternative paths would then be:

In node B:

| Destination | Connecting path | Weighting |
|---|---|---|
| D | bd | 1 − p₁ |
| D | ab | p₁ |

In node A:

| Destination | Connecting path | Weighting |
|---|---|---|
| D | ad | 1 − p₃ |
| D | ab | p₃ |

If these routing tables were used for a purely destination-based routing decision, then the probability of the case arising whereby, for example, a packet from network node B en route to network node D would be routed first via the connection ab to the network node A and then again from the network node A via the connection ab to the network node B would be p₁p₃. The probability that this would happen to a packet twice in succession would be (p₁p₃)². The probability of a packet being sent to and fro n times would be (p₁p₃)ⁿ. Consequently, the routing of packets from network node B to network node D would not be achieved loop-free.

In the case of the two currently available multipath routing mechanisms, Equal Cost Multipath, ECMP for short, under the OSPF protocol and Unequal Cost Multipath Routing, UCMR for short, under the EIGRP protocol from CISCO, the selection of alternative paths to a destination is severely restricted by the fact that, despite purely destination-based routing of packets, loops always have to be avoided. Under the ECMP and UCMR mechanisms, in the example shown in FIG. 1, the alternative paths from network node B to network node D via network node A and from network node A to network node D via network node B are not allowed and the connection ab cannot be used.

In the case of the “joker link” method, it is proposed in cases like the example described as per FIG. 1, that the distribution of traffic be disregarded and that the network nodes instead be given locally executable rules. The traffic distribution weighting for the critical alternative paths, i.e. the potential loop, is thus set to the minimum value, i.e. to zero. The paths are, however, kept in the routing table and designated so-called “joker links”. Corresponding routing tables would then be:

In node B:

| Destination | Connecting path | Weighting |
|---|---|---|
| D | bd | 1 |
| D | ab | 0 |

In node A:

| Destination | Connecting path | Weighting |
|---|---|---|
| D | ad | 1 |
| D | ab | 0 |

Apart from this, the nodes now use the rule that they use the links given the minimum traffic distribution weighting only if the desired adjacent network node or next hop can no longer be reached via any other path that has a positive weighting. The advantage of this method is that, especially in the case of multipath routing, a replacement path can be made available, with no packets circulating in the network. See also the corresponding proposal in the earlier patent application.

In practice, parallel connections or lines are frequently located between adjacent nodes. Often, these even run over different routes, i.e. they are physically or spatially separate from one another.

This case is represented in FIG. 2. FIG. 2 shows an arrangement according to FIG. 1 with the proviso that the connection or the connecting path bd is achieved by means of two connections or connecting paths bd1 and bd2.

Since the parallel connecting paths connect the same network nodes to one another, they are usually used as one connection with correspondingly increased total capacity.

Where the “joker link” proposal is applied, the connection with increased total capacity is protected by the joker link, in the example via network node A.

An object of the present invention is to improve routing in packet-switched data networks.

This object is achieved by the claims.

According to the invention, it is proposed that parallel connecting paths be used as independent or separate transmission paths.

The advantage of the invention is that in the case of parallel connections, the first connection, in the example according to FIG. 2 the connection bd1, can be protected by the second connection, in the example by the connection bd2, or vice versa. Also, no joker links, in the example in the network nodes B and A, have to be provided. In this way, the connecting paths of the data network are used more economically.

Advantageous embodiments of the invention are indicated in the dependent claims.

### BRIEF DESCRIPTION OF THE DRAWINGS

An exemplary embodiment of the invention is described in detail below with reference to the drawings, in which:

FIG. 2 shows a part of a packet-switched data network.

FIG. 3 shows a first upgrade of the packet-switched data network according to FIG. 2.

FIG. 4 shows a second upgrade of the packet-switched data network according to FIG. 3.

### DETAILED DESCRIPTION OF INVENTION

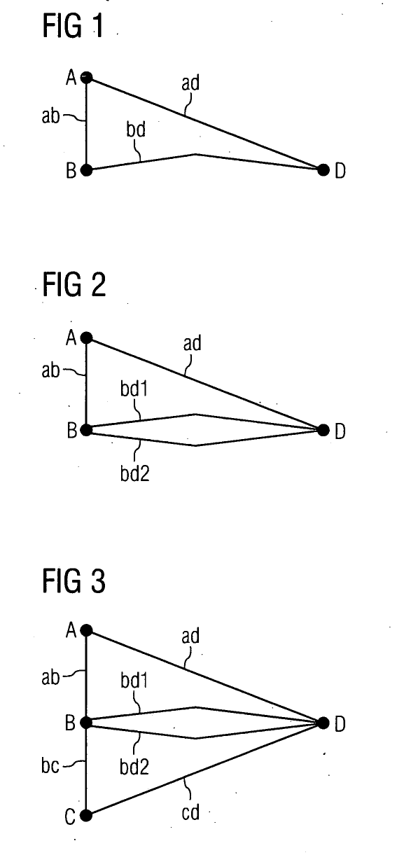

FIG. 2 shows a part, already mentioned in the introduction, of a packet-switched data network. Two connections bd1 and bd2 exist between the two network nodes A and D. These are maintained, provided or entered as independent or separate transmission paths in the routing table of the network node B.

Traffic of various traffic classes is supported and transmitted in the packet-switched data network. Lower classes of traffic, such as “best effort” traffic, can be discarded in the event of a jam. In order that the higher-grade traffic can still be switched on the remaining paths in the event of a disruption, the remaining link has alone to take over fully the high-grade traffic. The connecting paths are therefore normally loaded only to an appropriate degree with high-quality traffic. Lower-priority traffic is used normally to “fill up” unutilized capacities so as to enable full use to be made of the capacity of the connection.

An example of higher-priority data traffic is transmission-critical data traffic such as voice data which occurs in Internet telephony and in Voice over IP. An example of lower-priority data traffic is e-mail data traffic which can be transmitted with low priority in terms of time.

Higher-priority data traffic can, for example, be transmitted via a first connecting path and lower-priority data traffic via the second connecting path of the parallel connection. If one connecting path of the parallel connecting paths is disrupt ed, the network node is controlled such that lower-priority data traffic is at least in part discarded and predominantly higher-priority data traffic is transmitted.

Also, the higher- and lower-priority data traffic can be divided between the two transmission paths. This can be done by controlling the network node in accordance with known multipath routing distribution methods. In the event of a disruption, the router is controlled such that at least the higher-priority data traffic is transmitted via the disruption-free connecting path and residual capacity remaining is filled up with lower-priority data traffic.

If one of the links bd1 or bd2 fails, only one routing response in node B is required.

This will be illustrated using a network node B routing table.

In a normal case:

In node B:

| Destination | Connecting path | Weighting |
|---|---|---|
| D | bd1 | 0.5 |
| D | bd2 | 0.5 |

In the event of a disruption in the connection bd2:

In node B:

| Destination | Connecting path | Weighting |
|---|---|---|
| D | bd1 | 1 |

The entry of independent transmission paths achieves the traffic distribution desired in multipath routing for each node. “Joker links” in the network node B can be avoided since reciprocal, loop-free protection is provided by the independent or separate transmission paths. Also, the transport capacity reserved by network planning for the joker links can now be used for other data traffic. More effective use of the data network is achieved by this means.

According to the proposal described in the introduction regarding the joker link method in multipath routing, a joker link has to be set in network node A in order to achieve a rapid protective response in the event of link failures. The adjacent node A is also protected by the invention. Even in the adjacent node A, the joker link to network node B can be omitted and traffic distributed according to the multipath routing method. Since the network node B has two paths to the destination, no data traffic is sent to the destination network node D via network node A. Data traffic for destination network node D which arrives at network node A from the part of the data network that is not shown can be divided between two paths in accordance with multipath routing. Firstly, data traffic is sent direct to network node D via the connection ad. Secondly, data traffic which is always sent via one of the two connecting paths bd1 or bd2 to the destination network node D can be sent via the connecting path ab to the network node B. Since the network node B has two paths to the network node D, it will not according to a traffic distribution send any traffic back to network node A, as a result of which the routing is achieved loop-free. Loop-free multipath routing is achieved by means of this directed traffic to network node B.

A network node C which receives data traffic for destination network node D from the part of the data network not shown can likewise be protected by this measure as shown in FIG. 3. FIG. 3 shows an arrangement according to FIG. 2 subject to the proviso that a network node C is connected via a connection bc to the network node B and via a connection cd to the network node D. Network node C can, similarly to network node A, divide up its traffic according to multipath routing between two paths: firstly the direct path via the connection cd and secondly via the connection bc to network node B which routes the data traffic via the connection paths bd1 and/or bd2 to network node D.

Protection of the connections with the joker link proposal would under disruption-free conditions block the connections ab and bc for data traffic.

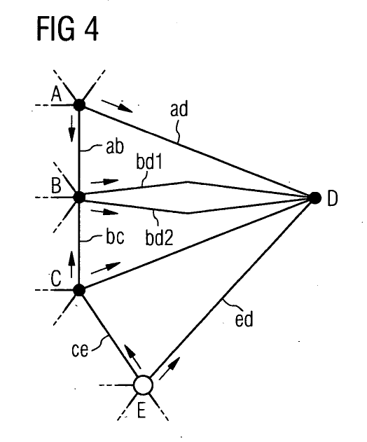

Further nodes, not shown here, in an analogous situation can also be protected. This principle can be extended to all nodes which lie on a continuous ring about D, as shown in extract in FIG. 4. FIG. 4 shows an arrangement according to FIG. 3 subject to the proviso that a further network node E is provided which is connected via a connecting path ce to the network node C and via a connecting path ed to the network node D. Directional arrows indicating the possible data flow in respect of data packets to the destination network node d are entered alongside the connections associated with the network nodes in order to make clear the described flow of data traffic.

The use of dual lines as independent routing connecting paths or the laying of dual lines upstream of destination network nodes achieves economical use of the data network, particularly in the case of multipath routing.

1.-7. (canceled)

8. A method of routing data packets to at least one target node in a packet-switched data network, the data network configured to provide for multipath routing of the data packets and having a plurality of network nodes with at least two parallel connecting paths connecting two adjacent network nodes, the adjacent network nodes each having a routing table including routing path information for data packets to be routed via the adjacent network nodes, the method comprising:
operating the parallel connecting paths as independent connecting paths by entering related routing information into the routing tables, if at least one of the adjacent network nodes is the target network node;
distributing data traffic between the adjacent network nodes among the parallel connecting paths, the data traffic including the data packets, such that the parallel connecting paths are independently operated; and
if one of the parallel connecting paths is faulty, re-routing such data traffic affected by the faulty connecting path via at least one alternative connecting path of the data network towards the target node.

9. The method according to claim 8, wherein the packet-switched data network is operated according to the Internet Protocol.

10. A network arrangement for multipath routing of data packets to a target node, the arrangement comprising:
a plurality of network nodes;
at least two parallel connecting paths for connecting at least a first and a second adjacent network node of the plurality of network nodes; and
a routing table assigned to the first and second adjacent network nodes and having routing path information for data packets to be routed via the first and second adjacent network nodes, the second adjacent network node being the target node, wherein the first adjacent network node:
refers to the parallel connecting paths as independent connecting paths in the routing table assigned to the first adjacent network node, and
is configured to re-route such data packets affected by a faulty connecting path via at least one alternative connecting path of the data network towards the target node, if one of the independent connecting paths is the faulty connecting path.
